(19) United States
(12) Patent Application Publication
(10) Pub. No.: US 2019/0362255 A1
(43) Pub. Date: Nov. 28, 2019

(54) SUGGESTING ACTION DATA BASED ON PAST CONDITIONS

(71) Applicant: Microsoft Technology Licensing, LLC, Redmond, WA (US)

(72) Inventors: Benjamen Ljudmilov Mateev, Berlin (DE); Manjot Singh Pal, Seattle, WA (US)

(21) Appl. No.: 15/990,348

(22) Filed: May 25, 2018

(51) Int. Cl. G06N 5/04; G06N 99/00

(52) U.S. Cl. CPC G06N 5/048; G06N 99/005

(57) ABSTRACT

Aspects of the present disclosure relate to systems and methods for suggesting action data based on one or more past conditions. For example, action data and one or more conditions surrounding the action data may be received. One or more action profiles for a user may be developed. Additional action data and an additional one or more conditions surrounding the additional action data may be received. A difference in the one or more action profiles and the additional action data may be identified. One or more suggestions may be generated for the user based on the identified difference in the one or more action profiles and the additional action data.

### BACKGROUND

To-Do lists, scheduling events, activities and tasks have become a part of everyday life for most people. As such, many people use a variety of software applications to create lists and schedule/calendar events, activities, and tasks. However, currently users of these applications are required to manually enter To-Do lists, items in their To-Do lists, events, activities and tasks. As such, current applications for creating lists and scheduling/calendaring events, activities, and tasks may be prone to human error. For example, a user of these applications may forget to add an item to their To-Do list or schedule an important activity or event. Furthermore, current techniques for creating lists and scheduling/calendaring events, activities, and tasks may be time consuming.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In summary, the disclosure generally relates to systems and methods for suggesting action data based on one or more past conditions. Action data and one or more conditions surrounding the action data from one or more applications for a user of the one or more applications may be received at a contextual model. One or more action profiles for the user of the one or more applications may be developed via a profile component. Additional action data and an additional one or more conditions surrounding the additional action data for the user of the one or more applications may be received at the contextual model. A difference in the one or more action profiles for the user of the one or more applications and the additional action data may be identified via a mapping component. One or more suggestions for the user of the one or more applications may be generated via a suggestion component based on the identified difference in the one or more action profiles and the additional action data.

In another aspect, a method for determining missed action data in one or more conditions is presented. The method may include receiving, at a contextual model, a first set of action data and a first set of conditions from one or more applications for a user of the one or more applications over a first time period, determining, via the contextual model, that when the first set of conditions exist, the first set of action data exists for the first set of conditions, receiving, at the contextual model, a second set of action data and a second set of conditions from the one or more applications for the user of the one or more applications over a second time period, identifying, via a mapping component, that the second set of conditions match the first set of conditions, determining, via the mapping component, whether the second set of action data matches the first set of action data, and when it is determined that the second set of action data does not match the first set of action data, generating, via a suggestion component, one or more suggestions for the user of the one or more applications based on a difference between the second set of action data and the first set of action data.

In further aspects, a method for improving a contextual model is presented. The method may include receiving, at the contextual model, action data and one or more conditions surrounding the action data from one or more applications for a user of the one or more applications, developing, via a profile component, one or more action profiles for the user of the one or more applications, receiving, at the contextual model, additional action data and an additional one or more conditions surrounding the additional action data for the user of the one or more applications, generating, via a suggestion component, one or more suggestions for the user of the one or more applications based on at least one difference in the one or more action profiles and the additional action data, receiving, at the contextual model, feedback data associated with the one or more suggestions for the user of the one or more applications, and adjusting the contextual model based on the received feedback data.

### DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 illustrates an exemplary contextual modeling system for suggesting action data based on one or more past conditions, according to an example aspect.

FIG. 2 illustrates one view of a To-Do application for creating actions, according to an example aspect.

FIG. 3 illustrates an exemplary method for suggesting action data based on one or more past conditions, according to an example aspect.

FIG. 4 illustrates an exemplary method for determining missed action data in one or more conditions, according to an example aspect.

FIG. 5 illustrates an exemplary method for improving a contextual model, according to an example aspect.

FIG. 6 illustrates a computing system suitable for implementing the enhanced contextual modeling technology disclosed herein, including any of the environments, architectures, elements, processes, user interfaces, and operational scenarios and sequences illustrated in the Figures and discussed below in the Technical Disclosure.

### DETAILED DESCRIPTION

Aspects of the disclosure are generally directed to generating action data suggestions based on one or more past conditions. For example, people generally have routines and/or patterns in their lives. People tend to create To-Do lists and enter events, activities, meetings, tasks and the like as an entry in a calendar application, for example. People also use digital assistant applications such as Cortana®. A routine may include actions/activities such as going to the gym at 8 am and reading emails at 930 am every Monday, Wednesday, and Friday. Another action/activity may include going grocery shopping and creating a list of items to purchase at the grocery store using an application such as To-Do, for example. In these scenarios, the system of the current disclosure may receive action data and one or more conditions (e.g., context) around these activities. For example, the action data may include any data associated with the action/activity such as, using the examples described above herein, data indicating that going to the gym and reading emails usually happen together and the list of items included in the grocery list. In another example, the one or more conditions may include a location of where the activity/event was created and/or performed, the time the activity was entered and/or performed, the application used to enter the activity/action, any other people involved in the activity/action, and the like.

The system may model an understanding of the actions/activities indicating a pattern or routine and the conditions surrounding the actions/activities over time. As such, the system may identify a future activity/action that is the same as a past activity/action and that the conditions surrounding the future activity/action are similar to the conditions surrounding the past activity/action. In some cases, the system may identify action data missing from the identified future activity that was included with the past activity having similar conditions as the future activity. In this regard, the system may generate a suggestion including the missing action data for the user. Using grocery shopping as an example, the system may develop an understanding that when certain conditions exist around a grocery list for a particular user of one or more applications, the grocery list always includes bananas, bread, and milk. The system may identify a future trip to the grocery store, for example on a user's calendar, and notice that this user's grocery list is missing milk. In this example, the system may suggest that the user add milk to her grocery list. For example, the user may have forgotten to put milk on her grocery list.

As discussed above, To-Do lists, scheduling events, activities and tasks have become a part of everyday life for most people. As such, many people use a variety of software applications to create lists and schedule/calendar events, activities, and tasks. However, currently users of these applications are required to manually enter To-Do lists, items in their To-Do lists, events, activities and tasks. As such, current applications for creating lists and scheduling/calendaring events, activities, and tasks may be prone to human error. For example, a user of these applications may forget to add an item to their To-Do list or schedule an important activity or event. Furthermore, current techniques for creating lists and scheduling/calendaring events, activities, and tasks may be time consuming.

Accordingly, aspects described herein include suggesting action data based on one or more past conditions. In one aspect, action data and one or more conditions surrounding the action data from one or more applications for a user of the one or more applications may be received at a contextual model. In one example, the one or more conditions include at least a location, a time, a date, a method of entering an action, an application used to create an action, people associated with an action, and a repetition of an application used to create an action. In one example, the action data may include data associated with at least one action. In one example, the contextual model includes at least a combination of statistical machine learning based techniques and rules.

One or more action profiles for the user of the one or more applications may be developed via a profile component. In one example, the one or more action profiles may include the action data and the one or more conditions surrounding the action data. Developing one or more action profiles for the user of the one or more applications may include executing a contextual modeling function to model an understanding of the one or more conditions surrounding the action data for the user of the one or more applications. Additional action data and an additional one or more conditions surrounding the additional action data for the user of the one or more applications may be received at the contextual model. In this regard, a difference in the one or more action profiles for the user of the one or more applications and the additional action data may be identified via a mapping component. Identifying a difference in the one or more action profiles for the user of the one or more applications and the additional action data may include mapping at least a portion of the additional action data to at least one of the one or more action profiles for the user of the one or more applications. In another example, identifying a difference in the one or more action profiles for the user of the one or more applications and the additional action data may include evaluating the additional one or more conditions surrounding the additional action data.

In yet another example, identifying a difference in the one or more action profiles for the user of the one or more applications and the additional action data may include determining that the additional one or more conditions surrounding the additional action data matches the one or more conditions surrounding the action data in the at least one of the one or more action profiles mapped to at least a portion of the additional action data. For example, a similarity percentage between the additional one or more conditions surrounding the additional action data and the one or more conditions surrounding the action data in the at least one of the one or more action profiles mapped to at least a portion of the additional action data may be calculated. In one example, when the similarity percentage is at least 90%, it is determined that the additional one or more conditions surrounding the additional action data matches the one or more conditions surrounding the action data in the at least one of the one or more action profiles mapped to at least a portion of the additional action data.

One or more suggestions for the user of the one or more applications may be generated via a suggestion component based on the identified difference in the one or more action profiles and the additional action data. In this regard, a technical effect that may be appreciated is that by providing one or more suggestions for the user of the one or more applications based on the identified difference in the one or more action profiles and the additional action data, the one or more applications used to create actions (e.g., activities, events, tasks, and the like) are improved. For example, via the contextual modeling technology described herein, the one or more applications predict and suggest action data that may otherwise be prone to human error (e.g., action data that a person forgets to create).

In another aspect, missed action data in one or more conditions may be determined. For example, a first set of action data and a first set of conditions from one or more applications for a user of the one or more applications may be received at a contextual model over a first time period. It may be determined that when the first set of conditions exist, the first set of action data exists for the first set of conditions. For example, the contextual modeling system may determine that a pattern exists for a given set of conditions and action data. That is, when the given set of conditions exist, the action data includes a given set of data associated with the action/activity. A second set of action data and a second set of conditions from the one or more applications for the user of the one or more applications may be received at the context model over a second time period. The contextual modeling system may identify, via a mapping component, that the second set of conditions match the first set of conditions. In this regard, it may be determined whether the second set of action data matches the first set of action data. When it is determined that the second set of action data does not match the first set of action data, one or more suggestions may be generated for the user of the one or more applications based on a difference between the second set of action data and the first set of action data. As such, another technical effect that may be appreciated is that generating one or more suggestions for the user of the one or more applications based on a difference between the second set of action data and the first set of action data facilitates a reduced error rate associated with one or more applications, ultimately reducing the likelihood of data entry errors.

In further aspects, a contextual model of the contextual modeling system is improved. For example, receiving, at the contextual model, action data and one or more conditions surrounding the action data from one or more applications for a user of the one or more applications may be received at the contextual model. One or more action profiles for the user of the one or more applications may be developed. Additional action data and an additional one or more conditions surrounding the additional action data for the user of the one or more applications may be received at the contextual model. One or more suggestions may be generated for the user of the one or more applications based on at least one difference in the one or more action profiles and the additional action data. Feedback data associated with the one or more suggestions for the user of the one or more applications may be received at the contextual model. The contextual model may be adjusted based on the received feedback data to improve the generated one or more suggestions for the user of the one or more applications. In another example, the contextual model may predict and automatically perform and/or implement suggestions for the user in view of the adjustment to the contextual model. As such, another technical effect that may be appreciated is that by adjusting the contextual model, the contextual model and/or the contextual modeling function may be improved and contextual modeling technology is improved to provide more accurate and better suggestions. Furthermore, contextual modeling technology is improved to predict and automatically perform/implement suggestions for a user of one or more applications.

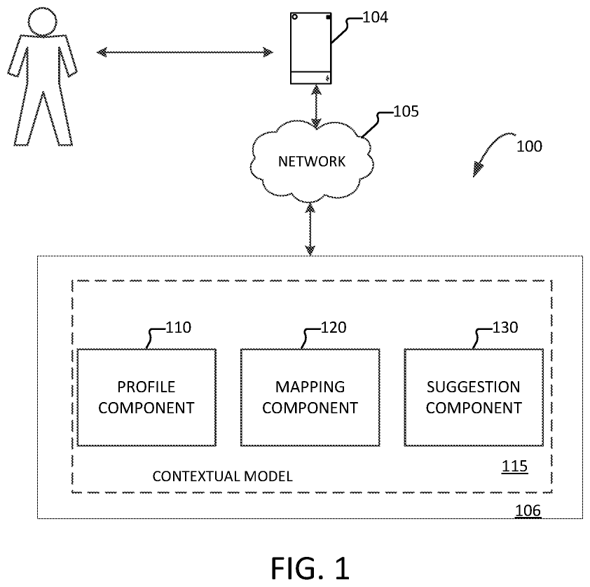

Referring now to the drawings, in which like numerals represent like elements through the several figures, aspects of the present disclosure and the exemplary operating environment will be described. With reference to FIG. 1, one aspect of a contextual modeling system 100 for suggesting action data based on past conditions is illustrated. In aspects, the contextual modeling system 100 may be implemented on a client computing device 104. In a basic configuration, the client computing device 104 is a handheld computer having both input elements and output elements. The client computing device 104 may be any suitable computing device for implementing the contextual modeling system 100 for suggesting action data based on past conditions. For example, the client computing device 104 may be at least one of: a mobile telephone; a smart phone; a tablet; a phablet; a smart watch; a wearable computer; a personal computer; a desktop computer; a laptop computer; a gaming device/computer (e.g., Xbox); a television; and etc. This list is exemplary only and should not be considered as limiting. Any suitable client computing device 104 for the contextual modeling system 100 for suggesting action data based on past conditions may be utilized.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an Intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

In aspects, the client computing device 104 may include a user interface component for rendering of one or more applications as described herein in a user interface of the client computing device 104 (not illustrated). In one example, the user interface component may be a touchable user interface that is capable of receiving input via contact with a screen of the client computing device 104, thereby functioning as both an input device and an output device. For example, content may be displayed, or output, on the screen of the client computing device 104 and input may be received by contacting the screen using a stylus or by direct physical contact of a user, e.g., touching the screen. Contact may include, for instance, tapping the screen, using gestures such as swiping or pinching the screen, sketching on the screen, etc.

In another example, the user interface component may be a non-touch user interface. In one case, a tablet device, for example, may be utilized as a non-touch device when it is docked at a docking station (e.g., the tablet device may include a non-touch user interface). In another case, a desktop computer may include a non-touch user interface. In this example, the non-touchable user interface may be capable of receiving input via contact with a screen of the client computing device 104, thereby functioning as both an input device and an output device. For example, content may be displayed, or output, on the screen of the client computing device 104 and input may be received by contacting the screen using a cursor, for example. In this regard, contact may include, for example, placing a cursor on the non-touchable user interface using a device such as a mouse.

In aspects, the contextual modeling system 100 may be implemented on a server computing device 106. The server computing device 106 may provide data to and from the client computing device 104 through a network 105. In aspects, the contextual modeling system 100 may be implemented on more than one server computing device 106, such as a plurality of server computing devices 106. In one example, the server computing device 106 includes a cloud service. In another example, the server computing device 106 includes an application service. The data may be communicated over any network suitable to transmit data. In some aspects, the network 105 is a distributed computer network such as the Internet. In this regard, the network 105 may include a Local Area Network (LAN), a Wide Area Network (WAN), the Internet, wireless and wired transmission mediums. In some aspects, the contextual modeling system 100 may be implemented on both a client computing device 104 and a server computing device 106.

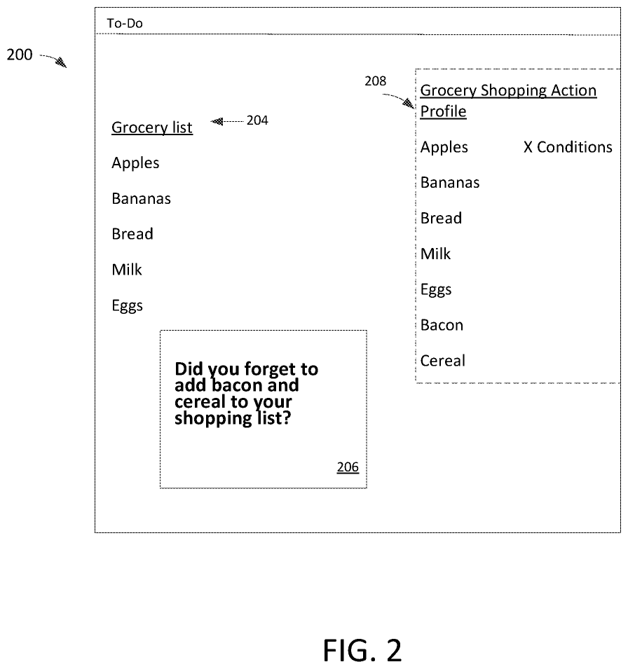

As illustrated in FIG. 1, the server computing device 106 may include a contextual model 115 which includes a profile component 110, a mapping component 120, and a suggestion component 130. The various components may be implemented using hardware, software, or a combination of hardware and software. In examples, a user interface component of the client computing device 104 may initiate rendering of one or more applications in a user interface of the client computing device 104 (e.g., as illustrated in FIG. 2). In some examples, the one or more applications may include software applications for creating and/or entering actions, activities, events, tasks, and the like. For example, the one or more applications may include software applications such as calendar applications, To-Do applications, Cortana®, email applications, and the like. The one or more software applications may be located at the client computing device 104 and/or at the server computing device 106.

In one example, the contextual model 115 may include at least a combination of statistical machine learning based techniques and rules. In some cases, the statistical machine learning based techniques may include techniques such as artificial neural networks, Bayesian classifiers, and/or genetically derived algorithms and/or functions. In one example, the contextual model 115 may be configured to receive action data and one or more conditions surrounding the action data from one or more applications for a user of the one or more applications. In one example, the action data may include any data associated with at least one action. For example, when the action includes an activity such as grocery shopping, the action data may include items on a grocery shopping list. In another example, when the action includes an activity such as cooking a meal, the action data may include a list of ingredients for cooking the meal. In another example, when the action includes an event or activity such as traveling, the action data may include a list of items a person usually brings with them when they travel such as phone charger, computer, passport, toothbrush, and the like. In another example, the action may include a pattern or routine of activities that are usually done together. For example, a user of the one or more applications may go to the gym every morning, read for an hour after the gym, and then meditate for an hour. In this example, the action data may include the activities in the routine (e.g., going to the gym, reading, and meditating).

In one example, the one or more conditions surrounding the action data include at least a location, a time, a date, a method of entering an action, an application used to create an action, people associated with an action, and a repetition of an application used to create an action. In one example, the location may include the location at which the action takes place. For example, in the examples described above, the location may include the grocery store, where the meal is being prepared and cooked, and the location of where the person is traveling to and from. In another example, the location may include the location at which the action and/or action data associated with action is created and/or entered. For example, the location may include the location at which a grocery list is created in a To-Do application, the location at which travel arrangements are entered into a calendar application, and the location at which ingredients for preparing a meal are created in a To-Do application. In one example, the time and the date may include a date and time at which the action takes place (e.g., is performed). For example, in the examples described above, the date and time may include the date and time the user is at the grocery store shopping, the date and time the meal is cooked, and the date and time the person is traveling (e.g., the dates of the travel). In another example, the date and the time may include the date and time of when the action and/or action data associated with the action is created and/or entered. For example, the date and time may include the date and time at which a grocery list is created in a To-Do application, the date and time at which travel arrangements are entered into a calendar application, and the date and time at which ingredients for preparing a meal are created in a To-Do application.

In one example, a method of entering an action and/or action data includes the container in which the action is created. For example, a first method of entering an action may include creating a list. For example, the action may include grocery shopping and items to pick up at a grocery store may be added to a grocery list using a To-Do application, for example. In another example, a second method of entering an action may include creating a calendar event. For example, travel arrangements may be entered and created using a calendar event. In another example, a third method of entering an action may include sending an email. For example, an email may be created that includes a task to be completed. In another example, a fourth method of entering an action may include using a digital assistant such as Cortana®. For example, a user may tell the digital assistant to remind them of an action and/or activity to be performed at a future time and/or that is part of a user's routine. In another example, a fifth method of entering an action may include the device used to enter the action. For example, the device may include a mobile device, a desktop device, a tablet device, and the like.

In one example, an application used to create an action and/or action data includes any of the one or more applications as described herein. For example, the one or more applications may include calendar applications, To-Do applications, Cortana®, email applications, and the like. In one example, people associated with an action may include people included in an email, people who a user does the action with, people necessary to perform the action, and the like. For example, a user of the one or more applications may go running with the same person every morning. In another example, a repetition of an application used to create an action may include the number of times and/or how often a user uses a particular application to create a particular action and/or to create many actions. For example, a user may always use a calendar application when creating a particular action (e.g., when traveling). In another example, a user may use a calendar application most often to create any action.

In another example, the contextual model 115 may be configured to receive additional action data and an additional one or more conditions surrounding the additional action data for the user of the one or more applications. For example, the additional action data may include action data similar to the action data described herein. The additional one or more conditions surrounding the additional action data may include the one or more conditions described herein. In one example, the additional action data and the additional one or more conditions surrounding the additional action data may be received at the contextual model 115 subsequent to initial action data and an initial one or more conditions surrounding the initial action data. In one example, the additional action data and the additional one or more conditions surrounding the additional data may include one or more conditions surrounding current action data. For example, the contextual model 115 may receive action data for an action that is currently being done and/or performed. In another example, the additional action data and the additional one or more conditions surrounding the additional data may include one or more conditions surrounding future action data. For example, the contextual model 115 may receive action data for an action that is being done and/or performed in the future. In this regard, the additional action data and the additional one or more conditions surrounding the additional action data (e.g., current and/or future action data, actions, and conditions) may be compared and mapped to action data and one or more conditions surrounding the action data previously received and processed by the contextual model 115.

In this regard, the profile component 110 may be configured to develop one or more action profiles for the user of the one or more applications. In one example, the one or more action profiles may include the action data and the one or more conditions surrounding the action data. In this regard, a user of the one or more applications may have an action profile developed for each action associated with the user. Each action profile may include the action data associated with the action and the one or more conditions surrounding the action data. For example, when the action is an activity such as traveling, the profile component 110 may develop a traveling action profile including action data associated with traveling for that user (e.g., a list of items the user usually packs when traveling) and one or more conditions surrounding the action data (e.g., the location associated with traveling and the list of items, the date/time information associated with traveling and the list of items, the application used to create the list of items and/or enter traveling arrangements, people involved, and the like).

Developing one or more action profiles for the user of the one or more applications may include executing a contextual modeling function to model an understanding of the one or more conditions surrounding the action data for the user of the one or more applications. The contextual modeling function may include any function suitable for modeling an understanding of the one or more conditions surrounding the action data for the user of the one or more conditions. For example, executing the contextual modeling function may assist in developing the one or more action profiles for a user. As discussed above, the one or more action profiles may include the action data and the one or more conditions surrounding the action data that models an understanding of the one or more conditions surrounding the action data for a user from action (e.g., activity, task, event) creation to action completion. In this regard, the contextual model 115 understands the one or more conditions for an action and the associated action data for a user and can generate suggestions and make predictions regarding current and/or future actions by the user.

In one example, the mapping component 120 may be configured to identify a difference in the one or more action profiles for the user of the one or more applications and the additional action data. The mapping component 120 may identify a difference in the one or more action profiles for the user of the one or more applications and the additional action data by executing a mapping function. The mapping function may be any function and/or algorithm suitable for performing, processing and executing any of the processes and steps described herein relative to the mapping component 120. For example, the mapping component 120 and/or the contextual model 115 may determine that a current or future action matches the action for which one of the one or more action profiles has been developed. For example, the mapping component 120 and/or the contextual model 115 may determine that a user of a calendar application is traveling in a week and that this user has a traveling action profile. In this example, the mapping component 120 and/or the contextual model 115 may determine that the one or more conditions surrounding the future traveling action are similar to the one or more conditions surrounding the action and/or action data in the traveling action profile. In this regard, the mapping component 120 and/or the contextual model 115 may evaluate the action data in the traveling action profile and the action data associated with the future traveling action/event. In one example, the mapping component 120 and/or the contextual model 115 may identify a difference in the action data in the traveling action profile and the action data associated with the future traveling action/event.

In one example, identifying a difference in the one or more action profiles for the user of the one or more applications and the additional action data may include mapping at least a portion of the additional action data to at least one of the one or more action profiles for the user of the one or more applications. For example, as discussed above, the mapping component 120 may evaluate the action data in an action profile and the action data associated with a future action that is the same as the action associated with the action profile. In some cases, the mapping component 120 may map at least some of the action data associated with the future action to at least some of the action data in the action profile. For example, some of the action data may be the same for the future action and the action profile. In another example, identifying a difference in the one or more action profiles for the user of the one or more applications and the additional action data may include evaluating the additional one or more conditions surrounding the additional action data. For example, as discussed above, the mapping component 120 and/or the contextual model 115 may determine that the additional one or more conditions surrounding a future action are similar to the one or more conditions surrounding the action and/or action data in the action profile.

In yet another example, identifying a difference in the one or more action profiles for the user of the one or more applications and the additional action data may include determining that the additional one or more conditions surrounding the additional action data matches the one or more conditions surrounding the action data in the at least one of the one or more action profiles mapped to at least a portion of the additional action data. For example, the mapping component 120 and/or the contextual model 115 may determine that the additional one or more conditions surrounding a future action match the one or more conditions surrounding the action and/or action data in the action profile (e.g., the action for which one of the one or more action profiles has been developed that matches the future action associated with the additional one or more conditions).

In one example, a similarity percentage between the additional one or more conditions surrounding the additional action data and the one or more conditions surrounding the action data in the at least one of the one or more action profiles mapped to at least a portion of the additional action data may be calculated. The calculated similarity percentage may indicate how similar the additional one or more conditions (e.g., conditions associated with a current or future action and/or action data) are to the one or more conditions in an action profile. When the similarity percentage reaches a particular percentage of similarity, the mapping component 120 may determine that the additional one or more conditions (e.g., conditions associated with a current or future action and/or action data) match the one or more conditions in an action profile.

In one example, when the similarity percentage is at least 85%, it is determined that the additional one or more conditions surrounding the additional action data matches the one or more conditions surrounding the action data in the at least one of the one or more action profiles mapped to at least a portion of the additional action data. In another example, when the similarity percentage is at least 90%, it is determined that the additional one or more conditions surrounding the additional action data matches the one or more conditions surrounding the action data in the at least one of the one or more action profiles mapped to at least a portion of the additional action data. In another example, when the similarity percentage is at least 95%, it is determined that the additional one or more conditions surrounding the additional action data matches the one or more conditions surrounding the action data in the at least one of the one or more action profiles mapped to at least a portion of the additional action data.

In one example, the suggestion component 130 may be configured to generate one or more suggestions for the user of the one or more applications. In one example, the suggestion component 130 may generate one or more suggestions for the user of the one or more applications based on the identified difference in the one or more action profiles and the additional action data. As discussed above, the mapping component 120 and/or the contextual model 115 may identify a difference in the action data in an action profile and the action data associated with a future action/event that matches the action profile. For example, the action data in the action profile may include a list of items to pick up while grocery shopping. The list may include apples, bananas, bread, and milk. The action data associated with a future grocery shopping event may include a list of items to pick up while grocery shopping. This list of items may include apples, bananas, and bread. In this example, the difference in the grocery items (e.g., the action data) includes milk. As such, the suggestion component 130 may generate a suggestion to the user that includes adding milk to their grocery list. As such, the one or more applications used to create actions (e.g., activities, events, tasks, and the like) are improved.

Referring now to FIG. 2, one view 200 of a To-Do application displayed on a user interface of the client computing device 104, such as a desktop computer, tablet computer or a mobile phone, for example, is shown. In one example, an application may include any application suitable for creating and/or entering actions, activities, tasks, events, and the like such as To-Do applications, email applications, calendar applications, digital assistant applications, and the like. As such, an exemplary application may be a To-Do application, as illustrated in FIG. 2.

As illustrated, the exemplary view 200 of the To-Do application displayed on the client computing device 104 includes a grocery list 204 and a suggestion 206. In the example illustrated in FIG. 2, the grocery list 204 includes apples, bananas, bread, milk, and eggs and the suggestion 206 includes bacon and cereal. In this regard, in accordance with the present disclosure, a user of the To-Do application may have a grocery shopping action profile 208. The action profile 208 may include action data including the items the user has in their grocery list under X conditions. The contextual model 115 may determine that a future grocery shopping trip by the user includes conditions similar to (e.g., conditions that match) the X conditions in the grocery shopping action profile 208. The contextual model 115 may determine that the grocery list (e.g., action data) in the grocery shopping action profile 208 under the matching conditions includes apples, bananas, bread, milk, eggs, bacon, and cereal. The contextual model 115 may identify a difference in the grocery list 204 (e.g., action data) in the future grocery shopping trip and the grocery list in the grocery shopping action profile 208. In the example illustrated in FIG. 2, the identified difference is bacon and cereal. As such, as illustrated in FIG. 2, the contextual model 115 may generate the suggestion 206 including suggesting adding bacon and cereal to the shopping list 204.

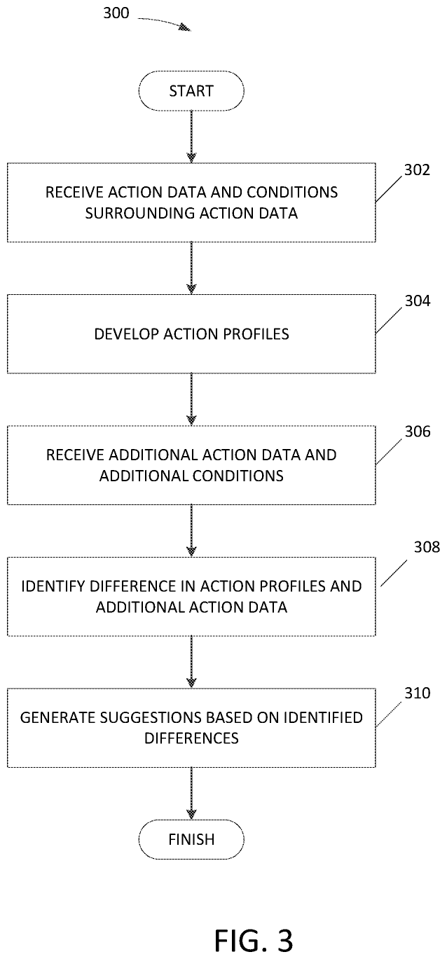

Referring now to FIG. 3, an exemplary method 300 for suggesting action data based on one or more past conditions, according to an example aspect is shown. Method 300 may be implemented on a computing device or a similar electronic device capable of executing instructions through at least one processor. Method 300 may begin at operation 302, where action data and one or more conditions surrounding the action data from one or more applications for a user of the one or more applications is received. In one example, the action data and one or more conditions surrounding the action data from one or more applications for a user of the one or more applications is received at a contextual model. In one example, the action data may include any data associated with at least one action. For example, when the action includes an activity such as grocery shopping, the action data may include items on a grocery shopping list. In another example, when the action includes an activity such as cooking a meal, the action data may include a list of ingredients for cooking the meal. In another example, when the action includes an event or activity such as traveling, the action data may include a list of items a person usually brings with them when they travel such as phone charger, computer, passport, toothbrush, and the like. In another example, the action may include a group of activities that are usually done together. For example, a user of the one or more applications may go to the gym every morning, read for an hour after the gym, and then meditate for an hour. In this example, the action data may include the group of activities done together (e.g., going to the gym, reading, and meditating). In one example, the one or more conditions surrounding the action data include at least a location, a time, a date, a method of entering an action, an application used to create an action, people associated with an action, and a repetition of an application used to create an action.

When action data and one or more conditions surrounding the action data from one or more applications for a user of the one or more applications is received, flow proceeds to decision operation 304 where one or more action profiles for the user of the one or more applications are developed. In one example, the one or more action profiles for the user of the one or more applications are developed via a profile component. In one example, developing one or more action profiles for the user of the one or more applications may include executing a contextual modeling function to model an understanding of the one or more conditions surrounding the action data for the user of the one or more applications. The contextual modeling function may include any function and/or algorithm suitable for performing, processing and executing any of the processes and steps described herein relative to the profile component and/or the contextual model for modeling an understanding of the one or more conditions surrounding the action data for the user of the one or more conditions.

When one or more action profiles for the user of the one or more applications are developed, flow proceeds to operation 306 where additional action data and an additional one or more conditions surrounding the additional action data for the user of the one or more applications are received. In one example, the additional action data and an additional one or more conditions surrounding the additional action data for the user of the one or more applications are received at the contextual model. In one example, the additional action data and the additional one or more conditions surrounding the additional action data may be received at the contextual model subsequent to initial action data and an initial one or more conditions surrounding the initial action data. In one example, the additional action data and the additional one or more conditions surrounding the additional data may include one or more conditions surrounding current action data. For example, the contextual model may receive action data for an action that is currently being done and/or performed. In another example, the additional action data and the additional one or more conditions surrounding the additional data may include one or more conditions surrounding future action data. For example, the contextual model may receive action data for an action that is being done and/or performed in the future. In this regard, the additional action data and the additional one or more conditions surrounding the additional action data (e.g., current and/or future action data, actions, and conditions) may be compared and mapped to action data and one or more conditions surrounding the action data previously received and processed by the contextual model.

When additional action data and an additional one or more conditions surrounding the additional action data for the user of the one or more applications are received, flow proceeds to operation 308 where a difference in the one or more action profiles for the user of the one or more applications and the additional action data is identified. In one example, the difference in the one or more action profiles for the user of the one or more applications and the additional action data is identified at a mapping component. The mapping component may identify a difference in the one or more action profiles for the user of the one or more applications and the additional action data by executing a mapping function. The mapping function may be any function and/or algorithm suitable for performing, processing and executing any of the processes and steps described herein relative to the mapping component. For example, the mapping component and/or the contextual model may determine that a current or future action matches the action for which one of the one or more action profiles has been developed. For example, the mapping component and/or the contextual model may determine that a user of a calendar application is traveling in a week and that this user has a traveling action profile. In this example, the mapping component and/or the contextual model may determine that the one or more conditions surrounding the future traveling action are similar to the one or more conditions surrounding the action and/or action data in the traveling action profile. In this regard, the mapping component and/or the contextual model may evaluate the action data in the traveling action profile and the action data associated with the future traveling action/event. In one example, the mapping component and/or the contextual model may identify a difference in the action data in the traveling action profile and the action data associated with the future traveling action/event.

When a difference in the one or more action profiles for the user of the one or more applications and the additional action data is identified, flow proceeds to operation 310 where one or more suggestions are generated for the user of the one or more applications based on the identified difference in the one or more action profiles and the additional action data. In one example, the one or more suggestions are generated for the user of the one or more applications based on the identified difference in the one or more action profiles and the additional action data at a suggestion component. In one example, the one or more suggestions are generated for the user of the one or more applications based on the identified difference in the one or more action profiles and the additional action data by executing a suggestion function. The suggestion function may include any function and/or algorithm suitable for performing, processing and executing any of the processes and steps described herein relative to the suggestion component.

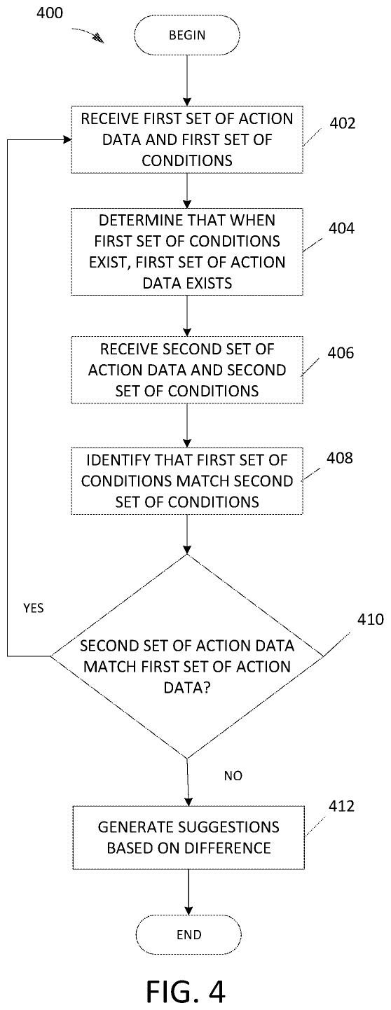

Referring now to FIG. 4, an exemplary method 400 for determining missed action data in one or more conditions, according to an example aspect is shown. Method 400 may be implemented on a computing device or a similar electronic device capable of executing instructions through at least one processor. Method 400 begins at operation 402 where a first set of action data and a first set of conditions from one or more applications for a user of the one or more applications is received over a first time period. In one example, the first set of action data and a first set of conditions from one or more applications for a user of the one or more applications is received over a first time period at a contextual model. In one example, the first set of action data may include any data associated with at least one action. For example, when the action includes an activity such as grocery shopping, the first set of action data may include items on a grocery shopping list. In another example, when the action includes an activity such as cooking a meal, the first set of action data may include a list of ingredients for cooking the meal. In another example, when the action includes an event or activity such as traveling, the first set of action data may include a list of items a person usually brings with them when they travel such as phone charger, computer, passport, toothbrush, and the like. In another example, the action may include a group of activities that are usually done together. For example, a user of the one or more applications may go to the gym every morning, read for an hour after the gym, and then meditate for an hour. In this example, the first set of action data may include the group of activities done together (e.g., going to the gym, reading, and meditating). In one example, the first set of conditions may include at least a location, a time, a date, a method of entering an action, an application used to create an action, people associated with an action, a type of device used to create the action, and a repetition of an application used to create an action. The first time period may include any time period where the contextual model is receiving action data and conditions for a particular user of one or more applications. For example, the first time period may be one day, one week, one month, multiple months, one year, and the like.

When a first set of action data and a first set of conditions from one or more applications for a user of the one or more applications is received over a first time period, flow proceeds to operation 404 where it is determined that when the first set of conditions exist, the first set of action data exists for the first set of conditions. For example, by receiving the first set of action data and the first set of conditions over a first time period, a repetitiveness of the same first set of action data with the first set of conditions is identified. In one example, it is determined that when the first set of conditions exist, the first set of action data exists for the first set of conditions via the contextual model. In one example, it is determined that when the first set of conditions exist, the first set of action data exists for the first set of conditions via the contextual model by executing a contextual modeling function. The contextual modeling function may include any function and/or algorithm suitable for performing, processing and executing any of the processes and steps described herein relative to the contextual model.

When it is determined that when the first set of conditions exist, the first set of action data exists for the first set of conditions, flow proceeds to operation 406 where a second set of action data and a second set of conditions from the one or more applications for the user of the one or more applications is received over a second time period. In one example, the second set of action data and the second set of conditions from the one or more applications for the user of the one or more applications is received over a second time period at the contextual model. In one example, the second time period is subsequent to the first time period. The second time period may include any time period where the contextual model is receiving the second set of action data and the second set of conditions for a particular user of one or more applications. For example, the second time period may be one day, one week, one month, multiple months, one year, and the like. In another example, the second time period may be the current time. In one example, the second set of action data may include any data associated with at least one action. In one example, the second set of conditions may include at least a location, a time, a date, a method of entering an action, an application used to create an action, people associated with an action, a type of device used to create the action, and a repetition of an application used to create an action. In one example, the second set of action data and the second set of conditions may include one or more conditions surrounding current action data. For example, the contextual model may receive action data for an action that is currently being done and/or performed. In another example, the second set of action data and the second set of conditions may include one or more conditions surrounding future action data. For example, the contextual model may receive action data for an action that is being done and/or performed in the future.

When a second set of action data and a second set of conditions from the one or more applications for the user of the one or more applications is received over a second time period, flow proceeds to operation 408 where it is identified that the second set of conditions match the first set of conditions. In one example, it is identified that the second set of conditions match the first set of conditions at a mapping component. In one example, identifying, via the mapping component, that the second set of conditions match the first set of conditions comprises calculating a similarity percentage between the second set of conditions and the first set of conditions. In one example, when the similarity percentage is at least 80%, it is determined that the second set of conditions match the first set of conditions. In another example, when the similarity percentage is at least 85%, it is determined that the second set of conditions match the first set of conditions. In another example, when the similarity percentage is at least 90%, it is determined that the second set of conditions match the first set of conditions. In another example, when the similarity percentage is at least 95%, it is determined that the second set of conditions match the first set of conditions. In one example, identifying, via the mapping component, that the second set of conditions match the first set of conditions comprises executing a mapping function of the mapping component. The mapping function may be any function and/or algorithm suitable for performing, processing and executing any of the processes and steps described herein relative to the mapping component.

When it is identified that the second set of conditions match the first set of conditions, flow proceeds to decision operation 410 where it is determined whether the second set of action data matches the first set of action data. In one example, the second set of action data matches the first set of action data when the second set of action data is the same as the first set of action data. In one example, it is determined whether the second set of action data matches the first set of action data via the mapping component. In one example, determining whether the second set of action data matches the first set of action data comprises executing a mapping function of the mapping component. The mapping function may be any function and/or algorithm suitable for performing, processing and executing any of the processes and steps described herein relative to the mapping component. When it is determined that the second set of action data matches the first set of action data, flow proceeds back to operation 402 where a first set of action data and a first set of conditions from one or more applications for a user of the one or more applications is received over a first time period.

When it is determined that the second set of action data does not match the first set of action data, flow proceeds to operation 412 where one or more suggestions are generated for the user of the one or more applications based on a difference between the second set of action data and the first set of action data. In one example, the one or more suggestions are generated for the user of the one or more applications based on a difference between the second set of action data and the first set of action data via a suggestion component. In one example, the difference between the second set of action data and the first set of action data comprises the action data in the first set of action that is missing from the action data in the second set of action data. In another example, the difference between the second set of action data and the first set of action data comprises the action data in the second set of action data that is different from the action data in the first set of action data. In one example, generating, via the suggestion component, one or more suggestions for the user of the one or more applications based on a difference between the second set of action data and the first set of action data comprises executing a suggestion function of the suggestion component. The suggestion function may include any function and/or algorithm suitable for performing, processing and executing any of the processes and steps described herein relative to the suggestion component.

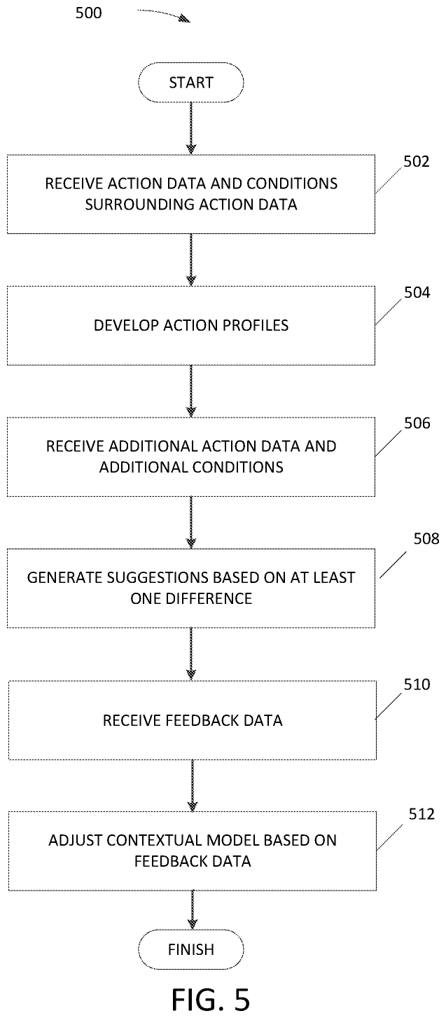

Referring now to FIG. 5, an exemplary method 500 for improving a contextual model, according to an example aspect is shown. Method 500 may be implemented on a computing device or a similar electronic device capable of executing instructions through at least one processor. Method 500 begins at operation 502 where action data and one or more conditions surrounding the action data from one or more applications for a user of the one or more applications is received. In one example, the action data and one or more conditions surrounding the action data from one or more applications for a user of the one or more applications is received at a contextual model. In one example, the action data may include any data associated with at least one action. For example, when the action includes an activity such as grocery shopping, the action data may include items on a grocery shopping list. In another example, when the action includes an activity such as cooking a meal, the action data may include a list of ingredients for cooking the meal. In another example, when the action includes an event or activity such as traveling, the action data may include a list of items a person usually brings with them when they travel such as phone charger, computer, passport, toothbrush, and the like. In another example, the action may include a group of activities that are usually done together. For example, a user of the one or more applications may go to the gym every morning, read for an hour after the gym, and then meditate for an hour. In this example, the action data may include the group of activities done together (e.g., going to the gym, reading, and meditating). In one example, the one or more conditions surrounding the action data include at least a location, a time, a date, a method of entering an action, an application used to create an action, people associated with an action, and a repetition of an application used to create an action.

When action data and one or more conditions surrounding the action data from one or more applications for a user of the one or more applications is received, flow proceeds to decision operation 504 where one or more action profiles for the user of the one or more applications are developed. In one example, the one or more action profiles for the user of the one or more applications are developed via a profile component. In one example, developing one or more action profiles for the user of the one or more applications may include executing a contextual modeling function to model an understanding of the one or more conditions surrounding the action data for the user of the one or more applications. The contextual modeling function may include any function and/or algorithm suitable for performing, processing and executing any of the processes and steps described herein relative to the profile component and/or the contextual model for modeling an understanding of the one or more conditions surrounding the action data for the user of the one or more conditions.

When one or more action profiles for the user of the one or more applications are developed, flow proceeds to operation 506 where additional action data and an additional one or more conditions surrounding the additional action data for the user of the one or more applications are received. In one example, the additional action data and an additional one or more conditions surrounding the additional action data for the user of the one or more applications are received at the contextual model. In one example, the additional action data and the additional one or more conditions surrounding the additional action data may be received at the contextual model subsequent to initial action data and an initial one or more conditions surrounding the initial action data. In one example, the additional action data and the additional one or more conditions surrounding the additional data may include one or more conditions surrounding current action data. For example, the contextual model may receive action data for an action that is currently being done and/or performed. In another example, the additional action data and the additional one or more conditions surrounding the additional data may include one or more conditions surrounding future action data. For example, the contextual model may receive action data for an action that is being done and/or performed in the future. In this regard, the additional action data and the additional one or more conditions surrounding the additional action data (e.g., current and/or future action data, actions, and conditions) may be compared and mapped to action data and one or more conditions surrounding the action data previously received and processed by the contextual model.

When additional action data and an additional one or more conditions surrounding the additional action data for the user of the one or more applications are received, flow proceeds to operation 508 where one or more suggestions are generated for the user of the one or more applications based on at least one difference in the one or more action profiles and the additional action data. In one example, the one or more suggestions are generated for the user of the one or more applications based on at least one difference in the one or more action profiles and the additional action data at a suggestion component. In one example, the one or more suggestions include the at least one difference in the one or more action profiles and the additional action data. In one example, the one or more suggestions are generated for the user of the one or more applications based on at least one difference in the one or more action profiles and the additional action data by executing a suggestion function. The suggestion function may include any function and/or algorithm suitable for performing, processing and executing any of the processes and steps described herein relative to the suggestion component.

When one or more suggestions are generated for the user of the one or more applications based on at least one difference in the one or more action profiles and the additional action data, flow proceeds to operation 510 where feedback data associated with the one or more suggestions for the user of the one or more applications is received. In one example, the feedback data associated with the one or more suggestions for the user of the one or more applications is received at the contextual model. In one example, the feedback data is any data that indicates to the contextual model the accuracy of the one or more generated suggestions. For example, the feedback data may indicate that the one or more suggestions were accurate and the user utilized the one or more suggestions. In another example, the feedback data may indicate that only one of the one or more suggestions was accurate and utilized by the user. In another example, the feedback data may indicate that none of the one or more suggestions were accurate (e.g., the user didn't utilize any of the suggestions). In one example, the feedback data includes additional action data and/or additional one or more conditions surrounding the additional action data.

When feedback data associated with the one or more suggestions for the user of the one or more applications is received, flow proceeds to operation 512 where the contextual model is adjusted based on the received feedback data. For example, the contextual model may be adjusted by changing and/or updating one of the functions and/or algorithms discussed herein. In another example, the contextual model may be adjusted to improve the one or more generated suggestions based on the received feedback. For example, the contextual model may be adjusted to generate more accurate suggestions. In one example, one or more additional suggestions for the user of the one or more applications may be generated consequent to adjusting the contextual model based on the received feedback data. In another example, one or more additional suggestions for the user of the one or more applications may be automatically performed (e.g., via the contextual model) consequent to adjusting the contextual model based on the received feedback. For example, instead of generating suggestions for a user, the contextual model may automatically perform the generated suggestions for the user. For example, instead of suggesting adding items to a grocery list, the contextual model may automatically add the items to the grocery list without providing a suggestion to the user to do so.

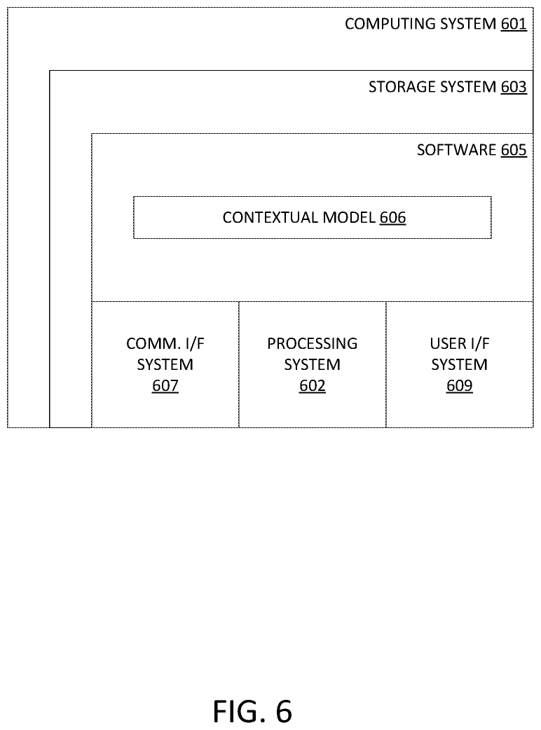

FIG. 6 illustrates computing system 601 that is representative of any system or collection of systems in which the various applications, services, scenarios, and processes disclosed herein may be implemented. Examples of computing system 601 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 601 may be implemented as a single apparatus, system, or device or may be implemented in a distributed manner as multiple apparatuses, systems, or devices. Computing system 601 includes, but is not limited to, processing system 602, storage system 603, software 605, communication interface system 607, and user interface system 609. Processing system 602 is operatively coupled with storage system 603, communication interface system 607, and user interface system 609.

Processing system 602 loads and executes software 605 from storage system 603.

Software 605 includes contextual model 606, which is representative of the components discussed with respect to the preceding FIGS. 1-5. When executed by processing system 602 to enhance contextual modeling, software 605 directs processing system 602 to operate as described herein for at least the various processes, operational scenarios, and sequences discussed in the foregoing implementations. Computing system 601 may optionally include additional devices, features, or functionality not discussed for purposes of brevity.

Referring still to FIG. 6, processing system 602 may comprise a micro-processor and other circuitry that retrieves and executes software 605 from storage system 603. Processing system 602 may be implemented within a single processing device, but may also be distributed across multiple processing devices or sub-systems that cooperate in executing program instructions. Examples of processing system 602 include general purpose central processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device, but may also be implemented across multiple storage devices or sub-systems co-located or distributed relative to each other. Storage system 603 may comprise additional elements, such as a controller, capable of communicating with processing system 602 or possibly other systems.

Software 605 may be implemented in program instructions and among other functions may, when executed by processing system 602, direct processing system 602 to operate as described with respect to the various operational scenarios, sequences, and processes illustrated herein. For example, software 605 may include program instructions for implementing enhanced contextual modeling systems.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtual machine software, or other application software, in addition to or that include contextual model 606. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to facilitate enhanced contextual modeling systems. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 609 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 609. In some cases, the input and output devices may be combined in a single device, such as a display capable of displaying images and receiving touch gestures. The aforementioned user input and output devices are well known in the art and need not be discussed at length here.

User interface system 609 may also include associated user interface software executable by processing system 602 in support of the various user input and output devices discussed above. Separately or in conjunction with each other and other hardware and software elements, the user interface software and user interface devices may support a graphical user interface, a natural user interface, or any other type of user interface.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

Among other examples, the present disclosure presents systems comprising: one or more computer readable storage media; and program instructions stored on the one or more computer readable storage media that, when executed by at least one processor, cause the at least one processor to at least: receive action data and one or more conditions surrounding the action data from one or more applications for a user of the one or more applications; develop one or more action profiles for the user of the one or more applications; receive additional action data and an additional one or more conditions surrounding the additional action data for the user of the one or more applications; identify a difference in the one or more action profiles for the user of the one or more applications and the additional action data; and generate one or more suggestions for the user of the one or more applications based on the identified difference in the one or more action profiles and the additional action data. In further examples, the one or more conditions include at least a location, a time, a date, a method of entering an action, an application used to create an action, people associated with an action, and a repetition of an application used to create an action. In further examples, the one or more action profiles comprise the action data and the one or more conditions surrounding the action data. In further examples, the action data comprises data associated with at least one action. In further examples, the action data and one or more conditions surrounding the action data are received from one or more applications for a user of the one or more applications at a contextual model and the contextual model includes at least a combination of statistical machine learning based techniques and rules. In further examples, to develop one or more action profiles for the user of the one or more applications, the program instructions, when executed by the at least one processor, further cause the at least one processor to at least model an understanding of the one or more conditions surrounding the action data for the user of the one or more applications. In further examples, to identify a difference in the one or more action profiles for the user of the one or more applications and the additional action data, the program instructions, when executed by the at least one processor, further cause the at least one processor to at least: map at least a portion of the additional action data to at least one of the one or more action profiles for the user of the one or more applications; evaluate the additional one or more conditions surrounding the additional action data; and determine that the additional one or more conditions surrounding the additional action data matches the one or more conditions surrounding the action data in the at least one of the one or more action profiles mapped to at least a portion of the additional action data. In further examples, to determine that the additional one or more conditions surrounding the additional action data matches the one or more conditions surrounding the action data in the at least one of the one or more action profiles mapped to at least a portion of the additional action data, the program instructions, when executed by the at least one processor, further cause the at least one processor to at least calculate a similarity percentage between the additional one or more conditions surrounding the additional action data and the one or more conditions surrounding the action data in the at least one of the one or more action profiles mapped to at least a portion of the additional action data. In further examples, when the similarity percentage is at least 90%, it is determined that the additional one or more conditions surrounding the additional action data matches the one or more conditions surrounding the action data in the at least one of the one or more action profiles mapped to at least a portion of the additional action data.

Further aspects disclosed herein provide an exemplary method for determining missed action data in one or more conditions, the method comprising: receiving a first set of action data and a first set of conditions from one or more applications for a user of the one or more applications over a first time period; determining that when the first set of conditions exist, the first set of action data exists for the first set of conditions; receiving a second set of action data and a second set of conditions from the one or more applications for the user of the one or more applications over a second time period; identifying that the second set of conditions match the first set of conditions; determining whether the second set of action data matches the first set of action data; and when it is determined that the second set of action data does not match the first set of action data, generating one or more suggestions for the user of the one or more applications based on a difference between the second set of action data and the first set of action data. In further examples, the second time period is subsequent to the first time period. In further examples, identifying that the second set of conditions match the first set of conditions comprises calculating a similarity percentage between the second set of conditions and the first set of conditions. In further examples, when the similarity percentage is at least 95%, it is determined that the second set of conditions match the first set of conditions. In further examples, the difference between the second set of action data and the first set of action data comprises the action data in the first set of action that is missing from the action data in the second set of action data. In further examples, the difference between the second set of action data and the first set of action data comprises the action data in the second set of action data that is different from the action data in the first set of action data. In further examples, identifying that the second set of conditions match the first set of conditions comprises executing a mapping function of a mapping component. In further examples, generating one or more suggestions for the user of the one or more applications based on a difference between the second set of action data and the first set of action data comprises executing a suggestion function of a suggestion component.

Additional aspects disclosed herein provide exemplary systems comprising: at least one processor; and memory encoding computer executable instructions that, when executed by the at least one processor, perform a method for improving a contextual model, the method comprising: receiving action data and one or more conditions surrounding the action data from one or more applications for a user of the one or more applications; developing one or more action profiles for the user of the one or more applications; receiving additional action data and an additional one or more conditions surrounding the additional action data for the user of the one or more applications; generating one or more suggestions for the user of the one or more applications based on at least one difference in the one or more action profiles and the additional action data; receiving feedback data associated with the one or more suggestions for the user of the one or more applications; and adjusting the contextual model based on the received feedback data. In further examples, the method further comprises generating one or more additional suggestions for the user of the one or more applications consequent to adjusting the contextual model based on the received feedback data. In further examples, the method further comprises automatically performing one or more additional suggestions for the user of the one or more applications consequent to adjusting the contextual model based on the received feedback.

Techniques for suggesting action data based on past conditions are described.

Although aspects are described in language specific to structural features and/or methodological acts, it is to be understood that the aspects defined in the appended claims are not necessarily limited to the specific features or acts described above. Rather, the specific features and acts are disclosed as example forms of implementing the claimed aspects.

A number of methods may be implemented to perform the techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods may be implemented via interaction between various entities discussed above with reference to the touchable user interface.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Additionally, while the aspects may be described in the general context of contextual modeling systems that execute in conjunction with an application program that runs on an operating system on a computing device, those skilled in the art will recognize that aspects may also be implemented in combination with other program modules. In further aspects, the aspects disclosed herein may be implemented in hardware.

Generally, program modules include routines, programs, components, data structures, and other types of structures that perform particular tasks or implement particular abstract data types. Moreover, those skilled in the art will appreciate that aspects may be practiced with other computer system configurations, including hand-held devices, multiprocessor systems, microprocessor-based or programmable consumer electronics, minicomputers, mainframe computers, and comparable computing devices. Aspects may also be practiced in distributed computing environments where tasks are performed by remote processing devices that are linked through a communications network. In a distributed computing environment, program modules may be located in both local and remote memory storage devices.

Aspects may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or compact servers, an application executed on a single computing device, and comparable systems.

What is claimed is:

1. A system comprising:
one or more computer readable storage media; and
program instructions stored on the one or more computer readable storage media that, when executed by at least one processor, cause the at least one processor to at least:
receive action data and one or more conditions surrounding the action data from one or more applications for a user of the one or more applications;
develop one or more action profiles for the user of the one or more applications;
receive additional action data and an additional one or more conditions surrounding the additional action data for the user of the one or more applications;
identify a difference in the one or more action profiles for the user of the one or more applications and the additional action data; and
generate one or more suggestions for the user of the one or more applications based on the identified difference in the one or more action profiles and the additional action data.

2. The system of claim 1, wherein the one or more conditions include at least a location, a time, a date, a method of entering an action, an application used to create an action, people associated with an action, and a repetition of an application used to create an action.

3. The system of claim 1, wherein the one or more action profiles comprise the action data and the one or more conditions surrounding the action data.

4. The system of claim 1, wherein the action data comprises data associated with at least one action.

5. The system of claim 1, wherein the action data and one or more conditions surrounding the action data are received from one or more applications for a user of the one or more applications at a contextual model, and wherein the contextual model includes at least a combination of statistical machine learning based techniques and rules.

6. The system of claim 1, wherein to develop one or more action profiles for the user of the one or more applications, the program instructions, when executed by the at least one processor, further cause the at least one processor to at least model an understanding of the one or more conditions surrounding the action data for the user of the one or more applications.

7. The system of claim 3, wherein to identify a difference in the one or more action profiles for the user of the one or more applications and the additional action data, the program instructions, when executed by the at least one processor, further cause the at least one processor to at least:
map at least a portion of the additional action data to at least one of the one or more action profiles for the user of the one or more applications;
evaluate the additional one or more conditions surrounding the additional action data; and
determine that the additional one or more conditions surrounding the additional action data matches the one or more conditions surrounding the action data in the at least one of the one or more action profiles mapped to at least a portion of the additional action data.

8. The system of claim 7, wherein to determine that the additional one or more conditions surrounding the additional action data matches the one or more conditions surrounding the action data in the at least one of the one or more action profiles mapped to at least a portion of the additional action data, the program instructions, when executed by the at least one processor, further cause the at least one processor to at least calculate a similarity percentage between the additional one or more conditions surrounding the additional action data and the one or more conditions surrounding the action data in the at least one of the one or more action profiles mapped to at least a portion of the additional action data.

9. The system of claim 8, wherein when the similarity percentage is at least 90%, it is determined that the additional one or more conditions surrounding the additional action data matches the one or more conditions surrounding the action data in the at least one of the one or more action profiles mapped to at least a portion of the additional action data.

10. A computer-implemented method for determining missed action data in one or more conditions, the method comprising:
receiving a first set of action data and a first set of conditions from one or more applications for a user of the one or more applications over a first time period;
determining that when the first set of conditions exist, the first set of action data exists for the first set of conditions;
receiving a second set of action data and a second set of conditions from the one or more applications for the user of the one or more applications over a second time period;
identifying that the second set of conditions match the first set of conditions;
determining whether the second set of action data matches the first set of action data; and
when it is determined that the second set of action data does not match the first set of action data, generating one or more suggestions for the user of the one or more applications based on a difference between the second set of action data and the first set of action data.

11. The computer-implemented method of claim 10, wherein the second time period is subsequent to the first time period.

12. The computer-implemented method of claim 10, wherein identifying that the second set of conditions match the first set of conditions comprises calculating a similarity percentage between the second set of conditions and the first set of conditions.

13. The computer-implemented method of claim 12, wherein when the similarity percentage is at least 95%, it is determined that the second set of conditions match the first set of conditions.

14. The computer-implemented method of claim 10, wherein the difference between the second set of action data and the first set of action data comprises the action data in the first set of action that is missing from the action data in the second set of action data.

15. The computer-implemented method of claim 10, wherein the difference between the second set of action data and the first set of action data comprises the action data in the second set of action data that is different from the action data in the first set of action data.

16. The computer-implemented method of claim 10, wherein identifying that the second set of conditions match the first set of conditions comprises executing a mapping function of a mapping component.

17. The computer-implemented method of claim 10, wherein generating one or more suggestions for the user of the one or more applications based on a difference between the second set of action data and the first set of action data comprises executing a suggestion function of a suggestion component.

18. A system comprising:
at least one processor; and
memory encoding computer executable instructions that, when executed by the at least one processor, perform a method for improving a contextual model, the method comprising:
receiving action data and one or more conditions surrounding the action data from one or more applications for a user of the one or more applications;
developing one or more action profiles for the user of the one or more applications;
receiving additional action data and an additional one or more conditions surrounding the additional action data for the user of the one or more applications;
generating one or more suggestions for the user of the one or more applications based on at least one difference in the one or more action profiles and the additional action data;
receiving feedback data associated with the one or more suggestions for the user of the one or more applications; and
adjusting the contextual model based on the received feedback data.

19. The system of claim 18, the method further comprising generating one or more additional suggestions for the user of the one or more applications consequent to adjusting the contextual model based on the received feedback data.

20. The system of claim 18, the method further comprising automatically performing one or more additional suggestions for the user of the one or more applications consequent to adjusting the contextual model based on the received feedback.
